(19) United States
(12) Patent Application Publication
(10) Pub. No.: US 2002/0198799 A1
(43) Pub. Date: Dec. 26, 2002

(54) Investment system

(76) Inventor: Kael Duaine Burden, Mesa, AZ (US)

Correspondence Address: Kenneth C. Booth, Schmeiser, Olsen & Watts LLP, 18 East University Drive, #101, Mesa, AZ, 85201, US

(21) Appl. No.: 09/886,334

(22) Filed: Jun. 21, 2001

(51) Int. Cl. G06F 17/60

(52) U.S. Cl. 705/35; 705/14

(57) ABSTRACT

An investment system and method of investing is disclosed whereby an investor may invest an amount of money through an investment machine at a convenient location. The investment machine may be independent of other investment machines, or may be networked to a plurality of investment machines accessing common databases. Embodiments of the invention involve receipt of a unique identifier, money and current investment preferences at the investment machine and initiation of the investment of the money on behalf of the investor by the investment machine. The investment machine may also be configured to display select advertising materials. Also disclosed is a reward or gift system whereby investment codes, having investable amounts associated therewith, may be either sold or given as a reward to encourage investment or other behavior by an investor.

### BACKGROUND OF THE INVENTION

1. Technical Field

This invention generally relates to electronic investment systems, and more particularly to an investment system involving an investment machine which permits investors to conveniently make small or large investments using whatever money is on hand.

2. Background Art

For many years, investment counselors have advised investors that “pennies add up” and that small, regular amounts of money, such as the money spent on unnecessary snacks, or other frivolous purchases, could be saved and invested for retirement. As used herein, the term “investor” is intended to include not only those who have invested money, but potential investors and others who may desire to invest money. If small amounts were saved and invested over time instead of being spent on unnecessary items, investors could find significant amounts available for retirement or for luxuries.

One frustration experienced by some investors is that once an amount of money is saved instead of spent, for example by not buying an extra doughnut for breakfast or buying a small drink instead of a large one, the money generally is not invested or saved for investing. Rather, the money gets spent on something else and does not end up in a long term investment. This frustration is generally experienced because there is currently no convenient means available for investors to invest small amounts of money immediately and remove it from the discretionary cash in a purchaser's pocket. For a $0.50 or $2.00 amount saved, for example by not purchasing a junk food item, it is extremely inconvenient to immediately take it down to the bank and place it in a savings account. Furthermore, even if it were worth the investor's time to go to an investment broker to invest the money, no broker would waste its time handling even a $10.00 investment. Such brokers conventionally require a relatively large amount of money, e.g. $500 to more than $20,000, to open an investment account, and charge brokerage fees for each transaction from a minimum of $8 to $1000 or higher per transaction. A further obstacle to saving large amounts of money through small savings over time is that such an approach leaves the temptation to spend the money in front of the investor for the duration of the savings period. Again, unless the money is locked away somewhere, the money which was saved by not spending it on certain unnecessary items is conventionally spent on different unnecessary items.

Known conventional methods for saving or investing small amounts of money over time fall primarily into four categories: 1) placing the money into a piggy bank or other savings account; 2) reinvesting interest earned on savings or investment accounts by allowing it to remain in the account; 3) providing monetary rewards to customers for spending money by depositing those monetary rewards into a trust or other retirement account; and 4) automatically rounding commercial transaction dollar amounts up to a dollar increment for commercial transactions and depositing the difference into a trust or other retirement account. The first and second categories are well known in the art and have been used for a very long time.

The third category involves retaining the rebate, coupon, or other amounts which are conventionally paid back to a shopper by a retailer, such as a store chain or credit card company, and placing an equivalent monetary value into a trust account. The rewards are conventionally distributed through software coupled to a retailer's transaction register. The trust account is then distributed according to the instructions associated with the account. This may include investing monies which have grown to a certain degree on behalf of the investor in an established account, or donating them to charities. Examples of investment systems which fall into this third category may be found in U.S. Pat. Nos. 4,941,090 to McCarthy (Jul. 10, 1990), 5,787,404 to Fernandez-Holmann (Jul. 28, 1998), 5,991,736 to Ferguson et al. (Nov. 23, 1999) and 6,105,865 to Hardesty (Aug. 22, 2000).

The fourth category, automatically rounding commercial transaction dollar amounts up, involves a buyer entering into a commercial transaction with a seller, such as to buy groceries. Software coupled to the seller's transaction register automatically rounds the total bill for the transaction up to an amount dictated by the rules associated with the account. The rules may dictate, for example, that the amount should be rounded up to the nearest one or five dollars, that a certain percentage of the transaction bill should be added to increase the bill, or that a fixed dollar amount should be added to the transaction bill. The difference between the increased rounded bill amount and the original bill amount is then collected by the retailer or a third party and transferred to a trust account. The amount in the trust account is then distributed according to the rules governing the account, such as investing the amount in a retirement account, donating the amount to charity, saving the amounts for future use at a retail store, or placing the amounts into a bank account. Examples of systems which round transaction amounts up are described in U.S. Pat. Nos. 6,112,191 to Burke (Aug. 29, 2000) and 6,164,533 to Barton (Dec. 26, 2000).

For the systems described in reference to the third and fourth categories, wide use by many retailers may make the investment options widely accessible. However, rather than encourage users to save money, the systems encourage users to spend more money by requiring entry into commercial transactions with retailers to take advantage of the savings systems. Additionally, the available systems leave control of the savings to the retailers and do not provide alternative investment options at the time of the commercial transactions. Because the systems require entry into a commercial transaction, and leave control of the transaction to the retailers, these systems are ineffective for those who wish to merely save a small amount of money without spending any, or those who wish to select the specific amount of money to save. Additionally, to operate either of these types of systems, an interface with a retailer's existing transaction register system is necessary to appropriately round up the transaction amounts. Integration with a retailer's transaction register system is expensive and intrusive. For example, each retailer's transaction system may operate using a different operating system which would increase the interface costs if more than one retailer is used. The training and extended transaction time required of retailers by the system may also become burdensome and discourage customers from shopping at a particular retailer. Furthermore, if a globally managed savings system were to be implemented, some retailers would opt out rather than allow third parties to have access to and control over a portion of the retailer's transaction registers and system.

Thus, there is a need for a universally applicable investment system which enables investors to select and invest any amount of money conveniently.

### DISCLOSURE OF THE INVENTION

The present invention provides an investment system which includes an investment machine having a housing, a display, investor identifier, money receiver and processor. The investment machine may be used and displayed, for example, in any location in which an automated teller machine (ATM) may be displayed. The investment machine may also be networked with a plurality of investment machines at a plurality of locations; each investment machine accessing one or more common databases. Embodiments of the investment machine are configured to accept both small and large amounts of money for investment and enable investors to immediately invest any amount of money at any time, including small amounts of money saved by not spending the money in a commercial transaction, or change received from a transaction. One particular embodiment of the investment machine is configured to receive and use a unique investor identifier associated with an investor identification card to access information regarding that investor's investment accounts. The investment machine may then accept money and/or specific current investment preferences from the investor. One or more processors associated with the investment machine then associates the money received, the investor's identity and the investment preferences and sends a signal representative of a command to invest the money on behalf of the investor.

Embodiments of the invention are also configured to display advertising information in association with the investment machine which may be selected on the basis of the investments made, an investor's preferences or personal information, an investment machine location, or an investment machine sponsor. In another particular embodiment of the invention, investment codes, such as may be associated with an investment card or bar code, are provided to investors as a promotional item or reward for a particular activity. The investment codes have associated therewith a monetary value amount which may be invested through an investment machine configured to accept investment codes. Alternatively, an investment code may be sold as a gift item to one who wishes to encourage investment activities in another who will receive the gift.

The present invention also discloses an investing method involving refraining from spending a sum of money and investing that money through an investment machine. The present invention also discloses a method of investing inside a commercial establishment including depositing in an investment machine an amount of money to invest which is unrelated to any transaction of the commercial establishment.

The foregoing and other features and advantages of the present invention will be apparent from the following more particular description of the particular embodiments of the invention, as illustrated in the accompanying drawings.

### BRIEF DESCRIPTION OF THE DRAWINGS

FIG. 1 is a perspective view of an investment machine configured according to an embodiment of the present invention;

FIG. 2 is a block diagram of an investment machine configured according to an embodiment of the present invention;

FIG. 3 is a block diagram of a central processor system including a plurality of investment machines and other associated hardware, software and connections according to an embodiment of the present invention; and

FIG. 4 is a process diagram of the operation of an investment machine according to an embodiment of the present invention.

### DETAILED DESCRIPTION OF EMBODIMENTS OF THE INVENTION

As discussed above, embodiments of the present invention relate to an investment system which enables investors to conveniently invest small or large amounts of money at convenient locations and without the requirement to enter into a previous commercial transaction. As used herein, to “invest” or make an “investment” is intended to encompass an exchange of money for a security such as may be handled by an investment broker and which may take the form of, but is not limited to, a bond, a stock, a mutual fund, a certificate of deposit (CD), a commercial paper, or other form of security. These securities commonly form the basis of particular accounts such as, for example, an investment retirement account (IRA), a 401 (k) account, a social security account, or other investment account. To “invest” or to make an “investment” is not intended to encompass placing money into or withdrawing money from a conventional bank or credit union checking or savings account.

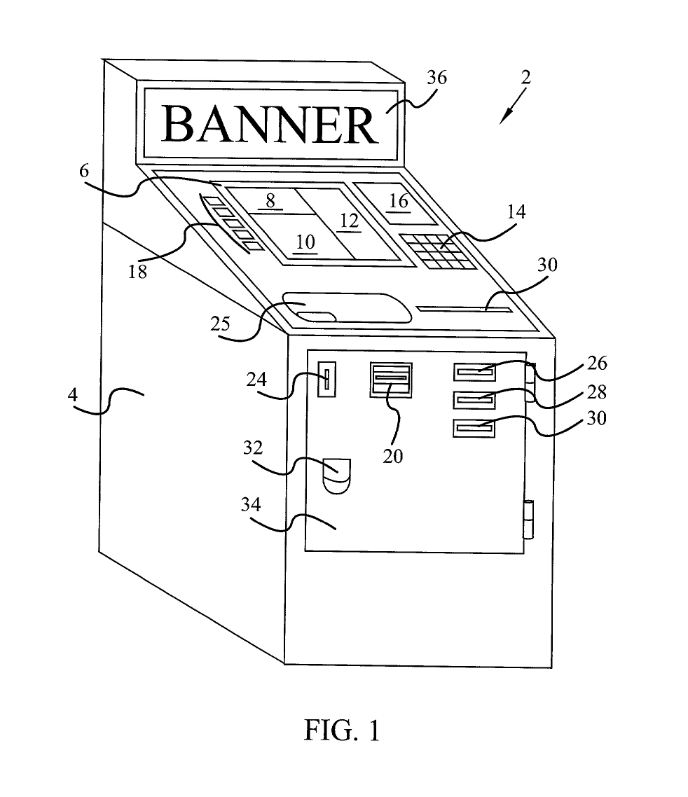

With reference to FIG. 1, an investment machine 2 is disclosed for use in a commercial establishment or other public location to allow all investors convenient access to investment opportunities. As shown in FIG. 1, the investment machine 2 includes a housing 4 to protect, support and provide structure for the investment machine. The housing may be formed of wood, plastic, metal, or any other material which provides adequate support and protection for the contents of the machine. Methods of manufacturing a suitable investment machine will be readily apparent to those of ordinary skill in the art from the description of the invention contained herein. The housing conventionally used in the art for automated teller machines (ATMs) and methods of their manufacture are one suitable example.

The investment machine 2 includes a display 6 at least partially contained within the housing 4 for displaying information relevant to the business of the machine. The display may optionally contain one or more display windows, such as display windows 8, 10 and 12, for separately displaying one or more categories of information relevant to the business of the machine. The display 6 may include any display known in the art (e.g., a cathode ray tube (“CRT”), plasma display, liquid crystal display (“LCD”), and/or a display based on light emitting diodes (“LED”)), and may be of any desired configuration, such as a square, rectangle, etc.

The investment machine also may include an interface for interacting with the information and options displayed on the display 6, though in some embodiments no interface is required. If employed, the interface may include any device configured to interact with the processor or display to select, remove, add to or otherwise alter the information displayed. Examples of common interfaces include a 10-key pad 14 or alphanumeric keyboard, a touchpad 16 or other touch sensitive surface, or one or more buttons or keys 18. Depending upon the options and information provided on the display 6, only one or none of these interface devices may be required. Alternatively, a touchscreen input may be used in the investment machine 2 as both the display 6, and the interface (see U.S. Pat. No. 5,951,397 to Dickinson (Sep. 14, 1999)).

The investment machine 2 also includes an investor identifier for identifying a particular investor using the machine 2. The investor identifier component of the investment machine 2 may be configured to recognize any identifier unique to the investor such as, for example, an alphanumeric personal identification number (PIN), either assigned to the investor or selected by the investor, a fingerprint, retina or other personal physical identifier, and the like. For a PIN used as a unique identifier, the investor identifier may accept the PIN either by entry at one of the display interfaces 14, 16 or 18, direct entry into a touch screen display 6, or through the use of an identification card with the PIN either mechanically, electronically, magnetically or otherwise imprinted thereon. There are many methods of indicating an investor's unique identifier in addition to a PIN including, but not limited to, bar codes, magnetic encoded data strips, “smart” cards with embedded microchips, “Bluetooth” technology electronic communicator, and any other form of identity verification including, magnetic, physical (i.e., thumb print, retinal scan, etc), digital, electronic or optical. One specific example of a magnetically imprinted identification card are those commonly used as credit cards including both a mechanically imprinted number and a magnetically encoded strip which may be read by a magnetic reader. For accepting and reading an identification card, the investment machine 2 may include an external identification card reader 20, or other reader, which is associated with a processor configured to determine the identity of the investor from the card.

“Bluetooth” technology, such as that manufactured by Motorola, Inc. having at least one division in Arizona, may be used to indicate the investor's identification through a small, short range, low-power, unlicensed, wireless transmitter or transceiver to a corresponding receiver or transceiver within an investment machine. With this technology, an investor need only approach an investment machine and it will automatically register the investor's identity, investor information and perhaps the investor's current investment preferences. Bar codes, magnetic encoded data strips and “smart” cards would require additional investment machine components, such as the card reader 20 shown in FIG. 1, to read the investor's identification from an identification card presented by the investor. PIN entry may be accomplished within a portion of a window for a touchscreen, or through an external PIN entry device such as a keyboard, keypad or cursor manipulating device such as a touchpad, rollerball or mouse. The use and function of identification devices such as readers and external PIN entry systems are well known in the art.

The investment machine 2 also includes a money receiver 22 for accepting money to invest. As used herein, the term “money” is intended to include not only cash, such as bills and coins, but also credit and debit cards, tokens, machine credits, coupons, and any other identifying numbers or tangible cards, coins or papers which have associated with them a monetary value or through which value may be received, and other forms of monetary exchange. Different embodiments of the investment machine 2 may include different varieties of money receivers 22 depending upon the money desired to be received by that particular investment machine 2. For the investment machine 2 shown in FIG. 1, the money receivers 22 shown include coin receivers 24 and 25, a bill receiver 26, a magnetic strip card receiver 28 and a credit slip receiver 30. Coin receiver 25 is configured to conveniently receive a plurality of coins simultaneously by providing a coin dish with a tapered slot near the bottom of the dish. Examples of coin dishes with a tapered slot near the bottom, and the hardware and software attached thereto to recognize the coins, may be found in a conventional change organizer machine conventionally located in shopping malls and other retail stores.

Each of the money receivers 22 used is a conventional money receiver known in the art and is associated with the required mechanical and electronic devices to enable it to function and communicate with a processor associated with the investment machine 2 to identify and sum the money deposited. Examples of coin and bill receivers which are known in the art include those commonly used on candy machines or dollar bill changers. Examples of magnetic strip and credit slip receivers include those commonly used at gas stations or other retail stores for recognizing credit cards or at parking garages to recognize parking slips.

Whenever money is involved, there is always a greater likelihood for fraud. To reduce the ability for criminals to fraudulently invest money or counterfeit money into an investment account, security measures may optionally be added to an investment machine configured according to an embodiment of the present invention. The security measures may include, for example, a visible or hidden security camera either within the investment machine or located nearby being associated with the investment machine by a communications device (e.g. wireless camera) to take a digital or other image of each user of the machine, similar to the images taken at an ATM during each ATM transaction. Additionally, other physical indicators may be scanned to record identity such as a retinal scan, finger print scan or facial marker scan, and stored in conjunction with the transaction data if desired for a particular level of security. Furthermore, if actual bills or coins are used with a particular investment transaction, images of those bills or coins may be captured and stored in conjunction with its respective transaction data through the use of a scanner associated with the bill or coin receiver to identify counterfeit money at a later time if identified.

It is contemplated that in more economical embodiments of the present invention, only one or two of the money receivers 22, such as the coin and bill receivers 24 and 26, will be used. It is also contemplated that the identification card receiver 20, the credit card receiver 28, and the credit slip receiver 30 may be combined into a single card receiver if the identification cards, credit cards and credit slips used with the investment machine each include similar magnetic strips. The timing as to when a particular card type should be entered may be coordinated by a processor associated with the investment machine 2 and indicated on the display 6.

Embodiments of the investment machine 2 may also include an investment report disburser 30 to print a detailed or summary report of a particular investment, investment account or account history, a receipt for an investment, or other relevant information. In one particular embodiment of the investment machine 2, the investment machine 2 is also configured to return change to an investor and includes a change return cup 32. The investment machine 2 may also include an access door 34 to provide access to the inside of the housing 4. The access door 34 may be configured such that all or some of the money receivers 22, the investor identifier 20, the report disburser 30 and the coin changer 32 are affixed thereto such that when the access door 34 is opened, each of the devices attached thereto are easily accessible. Alternatively, the access door 34 may be located adjacent to one or more of the devices on the same side of the housing, or may be located on a different side of the housing for convenience depending upon the location at which the investment machine will be used or displayed.

In a particular embodiment of the investment machine 2, one or more banners 36, such as advertising or informational banners, may be displayed on the housing 4 of the investment machine 2. The banners 36 may be painted on or otherwise adhered to the housing 4 with an appropriate adhesive known in the art, removably attached to the housing such as with velcro, magnets or hooks, or may be configured as an electronic display such as a light emitting diode (LED) display, a cathode ray tube (CRT) display, a plasma display, or other electronic display for enabling variations in the display information or enabling advertising specific to the investor using the machine 2. It is contemplated that the banners 36 may be of any shape or size, including designs surrounding the other features on the various surfaces of the investment machine 2.

One or more processors associated with the investment machine 2 coordinates and controls the images and information shown in the various windows 8, 10, 12 of the display, the money receivers 22, the investor identifier, the interfaces, the report disburser 30, the change return cup 32, the advertising banner 36, and any other peripheral device associated with the investment machine 2. The one or more processors may be at least partially enclosed within the housing 4, or completely enclosed therein, and accessed for maintenance and installation through the access door 34.

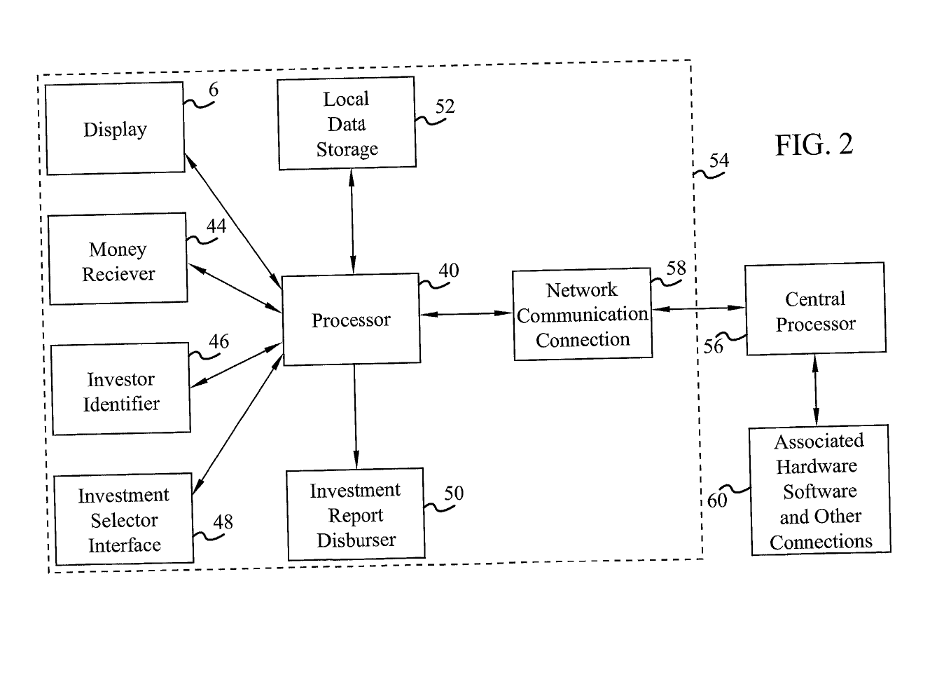

FIG. 2 includes a block diagram of an embodiment of the present invention wherein a single processor 40 is used to coordinate and control a display 6, a money receiver 44, an investor identifier 46, an investment selector interface 48 and an investment report disburser 50. The processor 40 also has associated therewith a local data storage device 52 such as a local hard drive, random access memory (RAM), or other magnetic or electronic data storage medium. The local data storage device 52 may be used for any number of data storage functions common to a processor, but is particularly useful for storing investment transaction information, account information, and other data necessary for the operation of the investment machine 2, such as an operating system and application software.

It will be understood by one of ordinary skill in the art that the investment machine 2 described in relation to the various embodiments of the invention may be configured as a stand-alone investment machine, or a networked investment machine. In one stand-alone investment machine embodiment, the local data storage is configured to store all investor identifier information for that location and data relating to each individual investor transaction since the last download of transaction data by an investor machine operator. In another stand-alone investment machine embodiment, the local data storage is configured to store not only all investor identifier information and data relating to each individual investor transaction for that location, but also investor account histories, investment performance histories, and the like. A portion of this data, such as investment performance histories, may be periodically updated from a separate database if desired.

In a networked embodiment, such as that shown in FIG. 2, the processor 40 of the investment machine 2 is configured to operate as a networked investment machine 54. The networked investment machine 54 is configured to interface with a central processor 56 through a network communication connection 58. The central processor 56 also includes connections to other associated hardware, software, and other connections 60 necessary to operate as a network. As should be clear to one of ordinary skill in the art, the foregoing description of a networked investment machine 54 may be implemented through a single display, or a group of displays housed in a decorative housing or housings and coupled, directly or indirectly, to a common central processor 56, such as through a local area network (“LAN”) and/or through a wide area network (“WAN”). Alternatively, multiple processors 40 or central processors 56 may have access to common investor information and other databases. Single or grouped investment machines and housings would particularly be useful in a grocery store, a shopping mall, a bank, a gas station, a hotel, a cafe, or other retail store, a recycle center, a casino or the like, where a variety of customers are passing or spending money or have money on hand which they may desire to invest rather than spend. With the embodiment of the investment machine display 6 illustrated in FIG. 1, multiple communication lines from the processor 40 or central processor 56 may be coupled to the display controller of an investment machine to relay display data to the multiple display windows 8, 10 and 12.

As will be clear to those of ordinary skill in the art, the network communication connection 58, and other communication lines described in relation to the embodiments of the invention, from the processor 40 to the central processor 56 or from the processor 40 or central processor 56 to the display may be configured in any number of configurations known in the art. Some examples of communications connections may include, without limitation, electronic or other data transferring cable (including optical as well as electrical), radio frequency wave transmissions including cellular frequency transmissions as well as microwave, satellite dish frequencies, etc., phone lines (again both optical and electrical) and the like, such as is common with remote communication systems. In select embodiments of the invention, however, several functions and display images for the investment machine 54, processor 40 and display 6 may be fixed by hardware and software included within the investment machine circuitry to minimize communication with the processor 40 or central processor 56. An investor's account information and other information may be retrieved at the investment machine location through the processor 40 or central processor 56 from a common investment information or account information database associated therewith. As used herein, the term “remote” means and includes sites using communication lines to communicate one or more signals with another site.

The investment machine display and interaction may also be implemented through an Internet or Intranet server as an Internet or Intranet display to be viewed by at least one Internet browser. In this way, connection to an investment machine, investment transactions and review and modification of investment accounts may be accomplished with only a connection to the server through a conventional phone or other data transmission line, digital signal line (“DSL”), T-1 line, coaxial cable, fiber optic cable, or other communications connection known in the art. It is will also be understood by those of ordinary skill in the art that enhanced bandwidth of digital wireless communications may render such technology suitable for some or all communications according to the present invention, particularly if such communications are encrypted. It will be further understood and appreciated by those of ordinary skill in the art that higher data transmission speeds may be useful for enhancing the sophistication and response of the display and interaction with the investor.

Even in an Internet embodiment, the investment machine display may be housed in a decorative housing and may have associated therewith one or more peripherals such as a money receiver, an investor identifier, an investment selection interface and an investment report disburser. One advantage of an Internet embodiment, however, is that investors may access an Internet investment machine page from any location where an Internet connection and computer, or other Internet facilitator, such as the so-called “WebTV” boxes, is available. The expansion in the number of computers and number and speed of Internet connections in recent years increases opportunities for investors to invest on a common investment system from home or work, as well as at a publically accessible investment machine.

As used herein, the term “Internet” is distinguished from a dedicated or proprietary LAN or WAN, and means and includes a plurality of mutually remote sites having the capability of communicating digital information, at least in part, through communication channels owned or controlled by third parties and being directed and, where necessary, relayed by servers or other suitable apparatus. Such communication channels may include, without limitation, electronic or other data transferring cable (including optical as well as electrical), radio frequency wave transmissions including cellular frequency transmissions as well as microwave, satellite dish frequencies, etc., phone lines (again both optical and electrical) and the like, such as is common with remote communication systems.

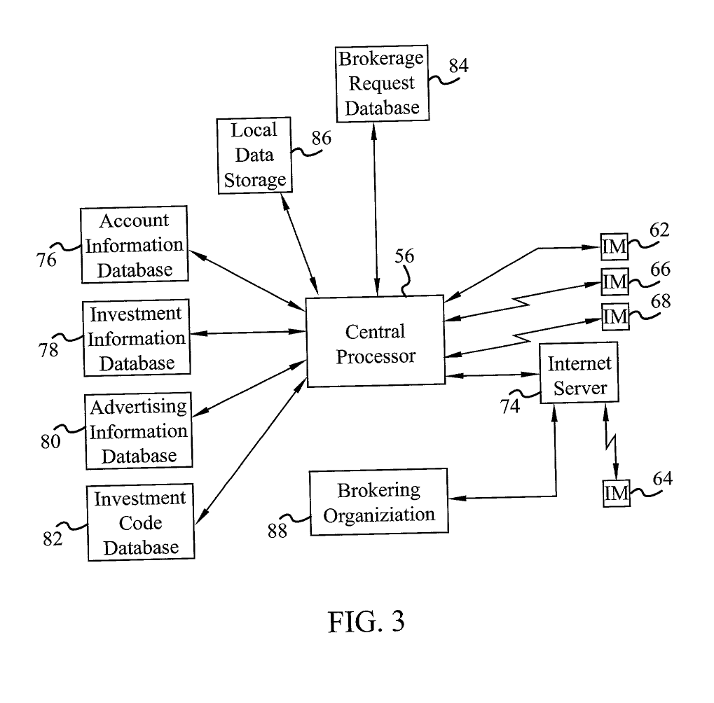

As illustrated in FIG. 3, a central processor 56 may be coupled to one or more investment machines (IM) 62, 64, 66 and 68. Those investment machines 62, 64, 66 and 68 may be coupled to the central processor 56 through any variety of network communications connections known in the art as discussed above. For the embodiments shown in FIG. 3, the investment machines are, respectively, hard wired to the central processor 56 through a coaxial cable (investment machine 62), linked through the Internet and an Internet Server 74 (investment machine 64), coupled through a telephone system to the central processor 56 (investment machine 66), and coupled through a cellular or other wireless communication connection to the central processor 56 (investment machine 68).

The central processor 56 may be coupled to any databases, third party organizations, or other software necessary to perform its functions. For an embodiment of the invention shown in FIG. 3, the databases and other links associated with the central processor include an Account Information Database 76, an Investment Information Database 78, an Advertising Information Database 80, an Investment Code Database, 82, a Brokerage Request Database 84, a Local Data Storage 86 and a Brokering Organization 88. The Account Information Database 76 may be associated with the central processor 56 to store and provide information on investors and their investments.

The information stored in the Account Information Database 76 relating to an investor may be as simple as the investor's unique identifier, name and address, or may additionally include such information as the investor's password, PIN or other identifier for security purposes, social security number, birth date, investment history, likes and dislikes, shopping preferences, investment preferences, investment options, preferred advertising, married/family status, gender, interests, hobbies, sports, spending habits, credit information, occupation, and other information, without limitation, which may assist an investment machine sponsor to transact with the investor more readily. Such sponsors may include, without limitation, retail stores, restaurants, airlines, rental agencies, investment brokers, product manufacturers, theaters, travel agencies, casinos, recycle centers, cities or other sponsor with a good or service the sponsor wishes to promote. The information stored in the Account Information Database 76 may be used to assist in selecting which information to retrieve from other associated databases, as explained hereafter, in addition to providing the information necessary to link the money tendered at an investment machine with a particular investor and a particular investment or set of investments.

The Investment Information Database 78 may be associated with the central processor 56 to store and provide information regarding specific investment transactions and other investment information. The information within this database, as with any of the databases associated with the central processor 56, may be coordinated for retrieval and storage through the central processor 56.

The Advertising Information Database 80 may be associated with the central processor 56 to store and provide information regarding advertising to be used by the various investment machine processors. All or a portion of the advertising information may alternatively or additionally be stored at each of the individual investment machines in association with their individual processors. The advertising information included within the Advertising Information Database 80 may include data representing specific advertisement images such as video clips or other graphics for use in a window of the investment machine display 6 or in a banner 36 of the investment machine (see FIG. 1).

Advertisements displayed at an investment machine may be selected on a random basis from the Advertising Information Database 80. Alternatively, the advertisements may be selected based upon the particular location of an investment machine, such as by displaying advertisements relating to the business of a particular commercial business at which the investment machine is used, or selected to relate to a sponsor of the investment machine. The advertisements may also be selected to relate specifically to the interests of the investor making an investment at a machine. For example, an appropriate advertisement may be selected on the basis of an investor's investment history, an investor's preferences or related personal information stored in the Account Information Database 76, or the specific investment the investor is presently investigating. Additionally, the central processor 56 or processor 40 of a specific investment machine may be configured to continuously display advertisements and cater the specific advertisements to the investor presently using the investment machine, or may be configured to display advertisements only after an investor has entered the investor's unique identifier. It is also contemplated that the advertising may include advertising relating to the use of an investment machine or to making investments generally, such as a tutorial, or some other description of the benefits of using an investment machine or a particular brand of investment machine. The advertising may also include information relating to news reports, public statements or other technology updates regarding particular companies in which investors may choose to invest.

The Investment Code Database 82 may be associated with the central processor 56 to store and provide information regarding investment codes provided to investors by a group interested in promoting particular actions by investors. It is contemplated that in association with various embodiments of the invention, an investment code having an investment amount associated therewith may be provided to an investor as a reward for a desired action by the investor, or to encourage the investor to invest through an investment machine. Desired actions by investors may include, but are not limited to, such actions as shopping at a particular store, attending or viewing a presentation, participating in a particular celebration, purchasing a particular product and the like.

The investment code may be provided as an alphanumeric code to an investor, or may be provided on a card or other device readable by the investment machine. In one particular embodiment, an investment card with a magnetic strip indicating a specific investment code or investment amount is provided to an investor. Cards with magnetic strips are well known in the art; however, two particularly suitable, inexpensive examples of magnetic strip cards are: first, those conventionally used to automatically record entry and exit times in a parking garage; and second, those used by theme parks, such as Disneyland®, to track the entry and exit of their guests to and from the park, as well as their selected activities in the park. In a second particular embodiment, a paper with a bar code, readable by the investment machine, is provided to an investor for use at an investment machine. The investment code or bar code may be printed on a sales receipt in conjunction with a commercial transaction with a retail business. In this way, the bar codes may be saved up or sent to a school, charity or other third party for their use.

An investment card may be provided to an investor as a promotional item, such as at the grand opening of a store, to encourage investors to attend the grand opening, or as a reward, such as for spending a particular amount of money at a store. Additionally, an investment card may have an amount associated with it relating to the amount of money spent at a particular store. For example, many businesses provide rewards to their customers for spending money in association with a particular business. These rewards are often awarded in the form of a cash rebate, a coupon, frequent shopper or flier points, and discounts on particular items. Instead of these types of rewards, or in addition to them, businesses may offer rewards in the form of an investment card for use in an investment machine located at that business or an affiliated business. In this way, businesses may encourage customers to engage in desired activities through the use of investment cards. Additionally, investors are provided with greater opportunities to invest for their futures, and to learn about investments. It is also contemplated that investment cards may be provided to investors to encourage use of an investment machine, for instance to encourage first-time use to expose investors to the advantages of investment machines.

Additionally, it is contemplated that investment codes or cards, such as those described herein, may be packaged and sold as gift items for purchase by one desiring to promote investment activities by another to whom the gift is given. For the investment codes or cards issued or approved by a retail store or other group, the issuing party may be billed periodically (e.g. daily, weekly or monthly), for the amounts associated with the investment cards or codes. Alternatively, an issuing party may purchase the right to associate an amount of money with the investment cards and codes, and periodically pay the balance of any excess money due or additional money needed to associate with future investment cards and codes. In select embodiments of the present invention, it is contemplated that a unique identifier may be associated with an investment card or code, such as by providing the unique identifier as part of the magnetic coding on a magnetic strip card, prior to an investment machine receiving the investment card or code. In such a case, the investment machine would include the necessary software and hardware to recognize and associate the unique identifier with the amount associated with the investment card or code without the investor entering the unique identifier. One advantage of prior association of the unique identifier with the investment code is that if the code is lost before it is used for an investment, the money may be easily recovered. Prior association of the unique identifier and an investment code may also shorten the time required to make an investment at an investment machine.

A Brokerage Request Database 84 may be associated with the central processor 56 to store and provide information regarding investment requests by investors through an investment machine. Information relating to investment requests may thereafter be periodically transferred to a brokering organization 88 or other investment entity. By periodically transferring the investment requests from the Brokerage Request Database 84, network connection traffic may be regulated and predicted, and investment requests may be handled in groups rather than being handled individually to reduce costs and time. Alternatively, the investment requests may be directly transferred to the brokering organization 88 or other investment entity from the processor or central processor. For example, when an investor makes an investment at an investment machine, that investment may be stored in a Brokerage Request Database 84 in association with the investor's unique identifier, or may be stored in association with a transaction number which is associated with the investor's unique identifier. The information relating to a plurality of investment requests may then be transferred as a group to the brokering organization 88, such as through the Internet, or directly to the brokering organization 88 if such a communication connection is available. Alternatively, the brokering organization 88 may periodically access and download a plurality of investment requests from the brokerage request database 84.

Like the processor 40 of the investment machine 54, the central processor 56 also includes a local data storage device 86 for storing data relevant to the operation of the central processor, such as an operating system, temporary data storage, other relevant operation software, and the like. As will be clear to one of ordinary skill in the art, the various databases and servers associated with the central processor may all be contained within a single database, within a single storage device, or may be subdivided to multiple databases or storage devices if convenient or desirable for a particular embodiment or application. Additionally, in select embodiments of the invention, the processor 40 of an investment machine 54 may be configured to include all of the relevant databases and connections necessary to operate as a central processor such that the required investments may be directly transferred to a brokering organization 88 or other investment entity without first communicating those investments to a separate processor. Furthermore, the central processor 56 may also be configured to include a display and the other peripheral devices, hardware and software, to operate as a processor of an investment machine.

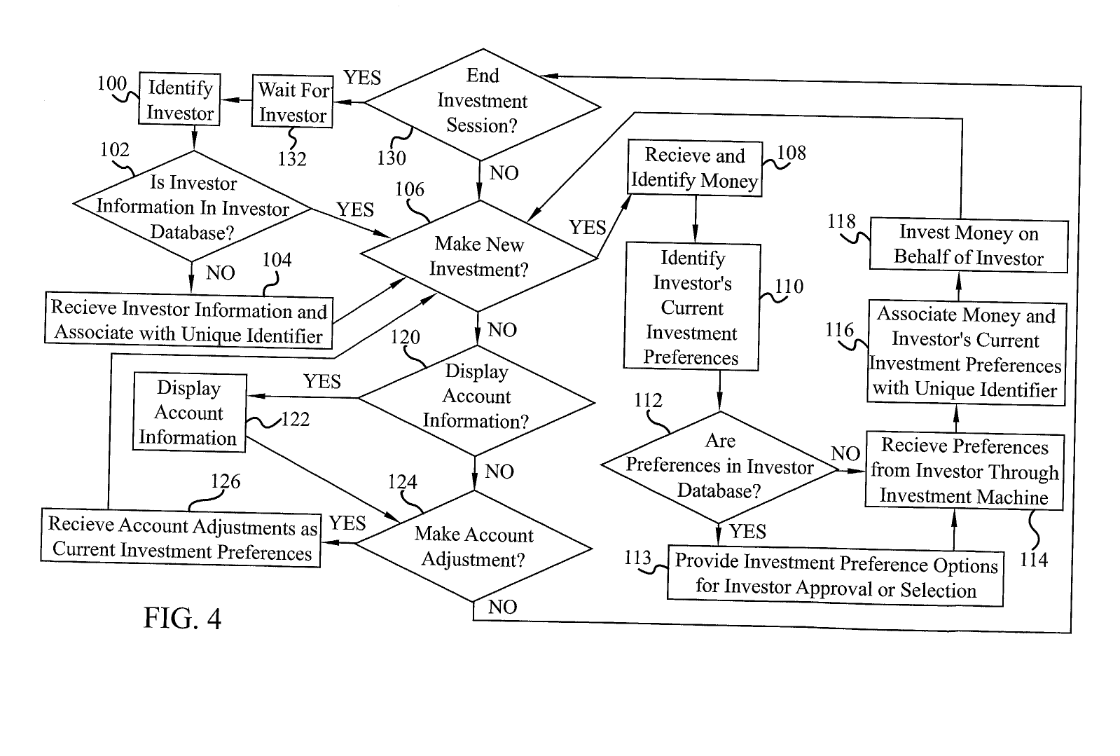

FIG. 4 illustrates a flow diagram of the operation of an embodiment of the present invention including a plurality of informational databases, an investment machine and a processor. In step 100 of the flow diagram, an investor approaches an investment machine and offers a form of identity unique to the investor. The identity, as explained in association with previous embodiments, may be provided in the form of a unique identifier configured as an alphanumeric PIN, an identification card, or other unique identifier data. In step 102, the investment machine performs a database query operation to determine whether the unique identifier data received is already contained in an associated investor information database. If the unique identifier is not contained within the investor information database (step 102), the investment machine, through an associated display device, may optionally provide prompts whereby an investor may establish an investment account with the investment machine and receive a unique identifier (step 104). Once the unique identifier has been assigned, or if a recognized unique identifier was entered, the investment machine may, for security purposes, require a password or other identifying indicia, such as a fingerprint or a signature recognized through appropriate pattern matching hardware and software known in the art, to ensure that the investor should be permitted access to the account associated with the unique identifier entered. In either case, however, once the investor has been properly identified as having rights to access account information, the investment machine may, through an associated display device, inquire whether the investor desires to make a new investment (step 106).

Following step 106 of FIG. 4, if an investor indicates a desire to make a new investment, the investment machine may prompt the investor to enter money, and will wait to receive and identify the money entered by the investor (step 108). Once the unique identifier and the money are received, the investment machine identifies the investor's current investment preferences (step 110). To identify the investor's current investment preferences, the investment machine may perform a database query to determine whether there are any investment preferences associated with the investor's unique identifier (step 112). If such preferences are already identified within an investor information database, the investment machine may then provide one or more investment preferences to the investor for approval, or for selection from among a plurality of preselected investment preference options (step 113). If such preferences are not already identified within the investor information database, the investment machine may provide a plurality of standard investment options from a database of options, such as investments relating to a sponsor of the investment machine. Alternatively, the investment machine may provide an index from which an investor may select one or more desired investment preferences. In either case, the investment machine receives current investment preferences from the investor through the investment machine (step 114) at substantially the same time as the investment machine receives the money. As used herein, “substantially the same time” is intended to mean a duration less than the duration between the time the investment machine receives a unique identifier (step 100) and the time when the investment machine ends the investment session with the investor (step 132).

After the current investment preferences are received by the investment machine (step 114), the investment machine may associate the money and the investor's current investment preferences with the investor's unique identifier (step 116). The investment machine then invests the money on behalf of the investor in accordance with the investor's current investment preferences (step 118). Step 118 may be accomplished either by directly contacting a brokerage organization or other investment entity through a network connection associated with the processor of the investment machine, or by creating an investment brokerage request file including data from which a brokerage organization or other investment entity may correctly invest the money on behalf of the investor. The investment machine may again inquire, through the associated display, whether the investor desires to make a new investment (step 106).

Following step 106 of FIG. 4, if an investor indicates that the investor does not wish to make a new investment, the investment machine may inquire, through the display device, whether the investor desires the investment machine to display or print a report detailing the investor's account information associated with the investor's unique identifier (step 120). If the investor indicates the investor would like to see the investor's account information, the processor associated with the investment machine may display or disburse a report including the account information after accessing the account information through a database associated with the processor, or through a network communication connection to a central processor and investor information database, depending on the configuration of the particular investment machine system (step 122).

Once the account information has been displayed (step 122), or if the investor does not want to view the account information when asked (step 120), the investment machine may then inquire, through an associated display, whether the investor would like to make an adjustment to the investment accounts associated with the unique identifier (step 124). If the investor desires to adjust any account allocations, such as moving money from one investment to another, withdrawing money, or the like, the processor may receive account adjustments as input from the investor, create current investment preference requests from the investor's input, and transmit the investment requests to the processor for investing on behalf of the investor (step 126). The investment machine may then inquire whether additional account adjustments are desired (step 124). When no more account adjustments are desired, the investment machine may inquire whether the investor desires to end the investment session (step 130). If not, the investment machine may again require whether the investor desires to make a new investment (step 106). If so, the investment machine may end the present investment session by restoring the display to its original prompts, such as “Please Enter Unique Identifier,” or by merely displaying advertising material, and will remain in a wait state until another unique identifier is entered or other interaction is attempted with the investment machine (step 132).

The present invention as described herein thus enables investors to quickly and conveniently access investment opportunities through placing investment machines configured according to one or more embodiments of the present invention in a plurality of convenient locations available to the public. By accepting coins, bills and other forms of money in any amounts, the investment machines of the present invention enable investors to conveniently invest even small amounts of money. In this way, investors may now immediately invest the small amounts of money they save by not spending it on unnecessary items. The investors maintain current control over their investment preferences and amounts of their investments, and are not required to enter into a separate commercial transaction to enable them to invest.

It will be clear to one of ordinary skill in the art that investments made through an investment machine configured according to one or more of the various embodiments of the present invention are governed by certain laws and regulations which may dictate the handling of investment requests and certain operations of the investment machines. It will be understood that specific handling rules and operations may be programmed into operating software or hardware associated with the processor and/or central processor and associated hardware and software of the embodiments of the invention. While the investment machines described herein as examples include many investment transaction features, it is anticipated by this disclosure that in simple embodiments of the invention an investment machine may be configured to accept only change and small bills and permit only investments in particular preselected investments. Alternatively, it is anticipated by this disclosure that another simple embodiment of the invention may be configured to accept only investment codes received elsewhere for investment at an investment machine, and not receive credit, coins or cash. Similarly, in simple embodiments with fewer features and allowable functions, it will be understood that less complex investment selection interfaces and money receivers will be required.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An investment machine for public use and display, the investment machine comprising:
a. a housing;
b. a display at least partially enclosed by the housing and viewable by an investor adjacent to the housing;
c. an investor identifier at least partially enclosed within the housing and configured to receive a unique identifier from the investor;
d. a money receiver at least partially enclosed within the housing and configured to receive and identify money to be invested; and
e. a processor at least partially enclosed within the housing and configured to receive input from the investor identifier and to transmit a signal representative of the input for use in investing at least a portion of the money in association with the unique identifier received from the investor.

2. The investment machine of claim 1, further comprising an investment selector interface configured to receive an investment preference from the investor and transmit the investment preference to the processor.

3. The investment machine of claim 2, wherein the investment selection interface includes at least one of a touch screen display, a touch sensitive surface, and a button.

4. The investment machine of claim 2, wherein the investment selector is configured to receive the investment preference from the investor at substantially the same time as the money receiver receives and identifies the money to be invested.

5. The investment machine of claim 1, further comprising a network communication connection coupled to the processor, the network communication connection configured to couple the processor of the investment machine to a central processor configured to store and coordinate investments made at each of a plurality of investment machines.

6. The investment machine of claim 5, wherein the network communication connection is further configured to couple the processor of the investment machine to the central processor at substantially the same time as the investor identifier receives the unique identifier from the investor.

7. The investment machine of claim 1, wherein the display is configured to display at least one of investment information, advertising information, and account information.

8. The investment machine of claim 7, wherein the advertising information is selected on the basis of one or more of an investor's investment activities, an investor's personal information, a location at which the investment machine is located and an identity of a sponsor of the investment machine.

9. The investment machine of claim 7, wherein the advertising information is one or more of an informational presentation, a tutorial, a news story, and other information relating to a particular company or its product in which an investor may desire to invest.

10. The investment machine of claim 1, wherein the money receiver is configured to receive one or more of a coin, a bill, a magnetic strip card, a bar code, a smart card and an alphanumeric code.

11. The investment machine of claim 1, further comprising an investment report disburser associated with the processor and configured to disburse a report associated with the investor's unique identifier.

12. A method of investing money, the method comprising:
associating a unique identifier with at least one person;
receiving money at an investment machine from the at least one person;
receiving current investment preferences through the investment machine from the at least one person; and
investing at least a portion of the money on behalf of the at least one person in accordance with the current investment preferences.

13. The method of claim 12, wherein receiving money at an investment machine comprises receiving at least one of a coin, a bill, a magnetic strip card, a bar code, a smart card and an alphanumeric code.

14. The method of claim 12, wherein receiving current investment preferences through the investment machine comprises receiving at least one of an indication from the investor that an investment option provided by the processor is preferred, an investment option preselected by the investor is preferred, and an investment option provided by the investor at the time of the indication is preferred.

15. A method of investing money using an investment machine, the method comprising:
inputting a unique identifier into an investment machine;
placing money to be invested into the investment machine; and
selecting a current investment preference option at the investment machine.

16. The method of claim 15, further comprising receiving an investment report from the investment machine.

17. The method of claim 15, wherein the money to be invested is in the form of at least one of a coin, a bill, a magnetic strip card, a bar code, a smart card and an alphanumeric code.

18. A method of promoting investment activities, the method comprising:
providing an investor with an investment code having associated therewith an investable amount of money;
receiving the investment card or investment code at a location for investing;
associating a unique identifier with the investor; and
investing at least a portion of the investable amount of money on behalf of the investor in association with the unique identifier.

19. The method of claim 18, wherein providing the investor with the investment code comprises printing the investment code on a printed sales receipt in association with a commercial transaction.

20. The method of claim 19, wherein the investment code is printed in the form of one of a magnetic code, a bar code, an electronic code, and an alphanumeric code.

21. The method of claim 18, wherein the investment code is provided as an investment card for insertion into an investment machine.

22. The method of claim 18, wherein the location for investing is one of an investment machine and an Internet site.

23. The method of claim 18, wherein providing an investor with the investment code comprises providing the investment code as a promotional item.

24. The method of claim 23, wherein the investment code is provided on the basis of one of a reward for an investor activity and an encouragement for investors to use an investment machine.

25. The method of claim 18, wherein providing an investor with the investment code comprises selling the investment code as a gift item.

26. The method of claim 18, wherein providing an investor with the investment code comprises offering the investment code in exchange for money paid in conjunction with a commercial transaction.

27. The method of claim 18, wherein the unique identifier is associated with the investment card or investment code prior to receiving the investment card or investment code at the location for investing.

28. A method of investing comprising:
refraining from spending a sum of money; and
investing at least a portion of the sum of money through an investment machine.

29. The method of claim 28, wherein refraining from spending a sum of money is done in association with a commercial business, and investing the portion of the sum of money through an investment machine is done within the same commercial business.

30. The method of claim 29, wherein the sum of money is unrelated to any other commercial transaction of the commercial business.

31. The method of claim 28, wherein investing the portion of the sum of money through an investment machine comprises:
entering a unique identifier into the investment machine;
depositing the sum of money into the investment machine; and
selecting a current investment preference through the investment machine.
